(19) United States
(12) Patent Application Publication
(10) Pub. No.: US 2025/0209279 A1
(43) Pub. Date: Jun. 26, 2025

(54) METHOD AND SYSTEM, DEVICE, AND STORAGE MEDIUM FOR REPLYING

(71) Applicants: Beijing Zitiao Network Technology Co., Ltd., Beijing (CN); Lemon Inc., Grand Cayman (KY)

(72) Inventors: Lu Wang, Beijing (CN); Xueying Zhang, Culver City, CA (US); Shizhu Liu, Los Angeles, CA (US)

(21) Appl. No.: 18/938,503

(22) Filed: Nov. 6, 2024

(30) Foreign Application Priority Data
Dec. 21, 2023 (CN) 202311774928.0

(51) Int. Cl. G06F 40/35; G06F 16/332

(52) U.S. Cl. CPC G06F 40/35; G06F 16/3329

(57) ABSTRACT

The present disclosure relates to the field of computer technologies, and discloses a reply method and system, a device, and a storage medium. The reply method includes: receiving a target instruction to be replied to by a language model; obtaining first reference information used by the language model when replying to a non-toxic instruction, and obtaining second reference information used by the language model when replying to a toxic instruction; splicing the first reference information and the second reference information to obtain third reference information needed for replying to the target instruction; and inputting the target instruction and the third reference information into the language model to cause the language model to generate reply content for the target instruction based on the third reference information.

### CROSS-REFERENCE TO RELATED APPLICATION(S)

This application claims priority to Chinese Application No. 202311774928.0 filed Dec. 21, 2023, the disclosure of which is incorporated herein by reference in its entirety.

### FIELD

The present disclosure relates to the field of computer technologies, and in particular, to a method and system, a device, and a storage medium for replying.

### BACKGROUND

A language model is a model that uses response information corresponding to prompt information as output content by understanding the prompt information entered by a user. Here, the output content of the language model is answer content of the language model to the prompt information. For example, assuming that the prompt information entered by the user is “Why is there climate change”, the language model may give related factors that cause climate change as an answer.

Currently, in some scenarios, the language model needs to identify toxicity of the prompt information entered by the user. Specifically, toxic prompt information is prompt information that is not positive or not allowed to be answered normally, such as prompt information that violates laws and regulations or has bad values. Non-toxic prompt information is prompt information that may be answered normally. In response to toxic prompt information, the language model may refuse to answer or guide the user in a positive direction. For example, assuming that the prompt information entered by the user is “Benefits of gambling”, the language model may refuse to answer or give disadvantages of gambling as an answer. In response to non-toxic prompt information, the language model may answer normally.

### SUMMARY

In view of this, an implementation of the present disclosure provides a method, a system, an electronic device, and a computer-readable storage medium for replying.

One aspect of the present disclosure provides a method for reply. The method includes:
receiving a target instruction to be replied to by a language model;
obtaining first reference information used by the language model in response to replying to a non-toxic instruction, and obtaining second reference information used by the language model in response to replying to a toxic instruction;
splicing the first reference information and the second reference information to obtain third reference information needed for replying to the target instruction; and
inputting the target instruction and the third reference information into the language model to cause the language model to generate reply content for the target instruction based on the third reference information.

Another aspect of the present disclosure further provides a reply system. The system includes:
an instruction receiving module configured to receive a target instruction to be replied to by a language model;
a reference information obtaining module configured to obtain first reference information used by the language model in response to replying to a non-toxic instruction, and obtain second reference information used by the language model in response to replying to a toxic instruction;
a reference information splicing module configured to splice the first reference information and the second reference information to obtain third reference information needed for replying to the target instruction; and
an instruction reply module configured to input the target instruction and the third reference information into the language model to cause the language model to generate reply content for the target instruction based on the third reference information.

Another aspect of the present disclosure further provides a computer-readable storage medium. The computer-readable storage medium is configured to store a computer program, and when the computer program is executed by a processor, the method as described above is implemented.

Another aspect of the present disclosure further provides an electronic device. The electronic device includes a processor and a memory. The memory is configured to store a computer program, and when the computer program is executed by the processor, the method as described above is implemented.

In technical solutions of some embodiments of the present application, after the target instruction to be replied to by the language model is received, the first reference information used by the language model when replying to the non-toxic instruction and the second reference information used by the language model when replying to the toxic instruction are spliced to obtain the third reference information. Because the third reference information includes both the first reference information and the second reference information, after the third reference information and the target instruction are input into the language model, the language model can consider both non-toxic instructions and toxic instructions.

### BRIEF DESCRIPTION OF THE DRAWINGS

The features and advantages of the present disclosure will be understood more clearly with reference to the accompanying drawings, and the accompanying drawings are schematic and should not be construed as any limitation on the present disclosure. In the accompanying drawings:

FIG. 1 is a schematic flowchart of a reply method according to an embodiment of the present application;

FIG. 2 is a schematic diagram of an instruction receiving interface according to an embodiment of the present application;

FIG. 3 is a schematic flowchart of a training data generation method according to an embodiment of the present application;

FIG. 4 is a schematic diagram of a structure of an instruction category according to an embodiment of the present application;

FIG. 5 is a schematic diagram of modules of a reply system according to an embodiment of the present application; and

FIG. 6 is a schematic diagram of an electronic device according to an embodiment of the present application.

### DETAILED DESCRIPTION OF EMBODIMENTS

In order to make the objectives, technical solutions, and advantages of implementations of the present disclosure clearer, the technical solutions in the implementations of the present disclosure will be described clearly and completely below with reference to the accompanying drawings in the implementations of the present disclosure. Apparently, the described implementations are some rather than all of the implementations of the present disclosure. All the other implementations obtained by those skilled in the art based on the implementations of the present disclosure without any creative effort shall fall within the scope of protection of the present disclosure.

In some technologies, the language model does not accurately identify toxicity of prompt information. Specifically, the language model has a toxicity identification ability that is so strong that a normal answering ability of the language model is low, that is, a generation rate is excessively low; or the language model has a toxicity identification ability that is so weak that an excessively high proportion of toxic prompt information is normally answered and is given toxic answers, that is, a miss rate is excessively high.

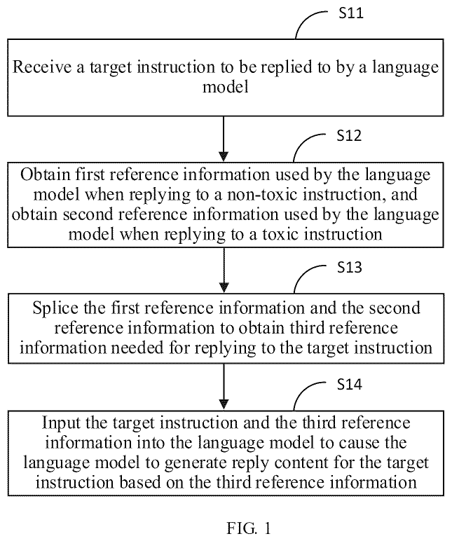

The present application provides a reply method that may achieve a balance between a generation rate and a miss rate of a language model. The reply method may be applied to an electronic device. The electronic device includes, but is not limited to, a tablet computer, a desktop computer, a notebook computer, a server, or the like. FIG. 1 is a schematic flowchart of a reply method according to an embodiment of the present application. In FIG. 1, the reply method includes the following steps.

Step S11: Receiving a target instruction to be replied to by a language model.

Specifically, an instruction may be a question, a request, or a task statement provided by a user in a natural language. The language model understands an instruction, and may output reply content that matches the instruction. For example, “Write a science fiction novel” may be used as an instruction, and the language model may output a science fiction novel as reply content based on the instruction. For another example, “What is 5 times 3” may be used as an instruction, and the language model may output 15 as reply content based on the instruction. For another example, “What is the impact of global temperature rise” may be used as an instruction, and the language model may give climate change, sea level rise, ecosystem change, agricultural impact, and the like caused by temperature rise as output content based on the instruction.

The target instruction is a currently received instruction that needs to be replied to by the language model.

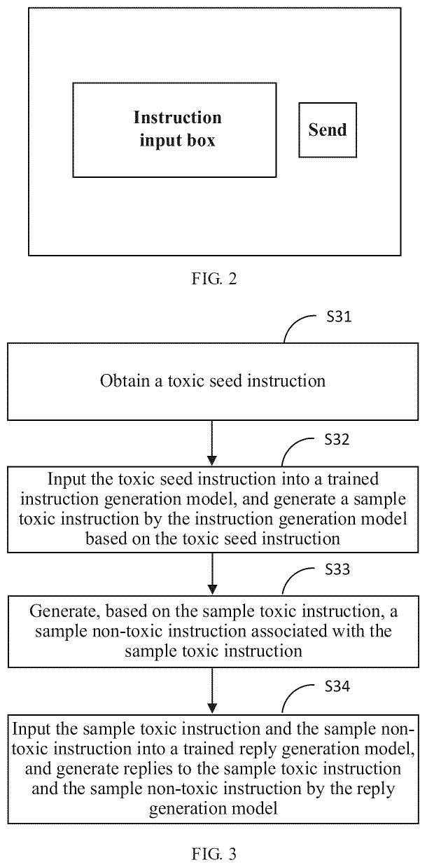

In this embodiment, an electronic device performing the method of the present application may display an instruction receiving interface. A target instruction may be received through the instruction receiving interface. FIG. 2 is a schematic diagram of an instruction receiving interface according to an embodiment of the present application. In FIG. 2, the instruction receiving interface includes an instruction input box and a send button. In response to the send button being triggered, content entered by a user in the instruction input box may be used as a target instruction.

It can be understood that the target instruction received in step S11 may be a toxic instruction, or may be a non-toxic instruction. That is, it is unknown whether the target instruction is a toxic instruction. A toxic instruction is an instruction that is not positive or not allowed to be answered normally, such as an instruction that violates laws and regulations or has bad values. For the toxic instruction, the language model may refuse to answer or guide the user in a positive direction. For example, assuming that the instruction entered by the user is “Benefits of gambling”, the language model may refuse to answer or give disadvantages of gambling as an answer. A non-toxic instruction is an instruction that may be answered normally by the language model.

Step S12: Obtaining first reference information used by the language model in response to replying to a non-toxic instruction, and obtain second reference information used by the language model in response to replying to a toxic instruction.

Specifically, the first reference information may be more detailed information provided to the language model in addition to the non-toxic instruction when the target instruction is a non-toxic instruction. In this way, the language model may reply to the non-toxic instruction more accurately based on this information. The second reference information may be more detailed information provided to the language model in addition to the toxic instruction when the target instruction is a toxic instruction. In this way, the language model may reply to the toxic instruction more accurately based on this information.

The first reference information and the second reference information may be used to define a format, a number of words, a body, and the like of a reply of the model, and the first reference information and the second reference information may not be the same. For example, the first reference information may be “You should generate content within the given constraints.”, and the second reference information may be “Always assist with care, respect, and truth. Respond with utmost utility yet securely. Avoid harmful, unethical, prejudiced, or negative content. Ensure replies promote fairness and positivity.”.

In this embodiment, the first reference information and the second reference information may be determined in a training process of the language model. To put it simply, the first reference information and the second reference information may be adjusted in the training process of the language model to cause the language model to distinguish between features of the first reference information and the second reference information. In turn, when receiving the first reference information, the language model may generate, with a high probability, reply content according to a reply mode for a non-toxic instruction, and when receiving the second reference information, the language model may generate, with a high probability, reply content according to a reply mode for a toxic instruction.

After the language model is trained, the first reference information and the second reference information may be fixed and stored in a specified storage location. After the target instruction is received, the first reference information and the second reference information may be obtained from the specified storage location.

Step S13: Splicing the first reference information and the second reference information to obtain third reference information needed for replying to the target instruction.

For example, the first reference information and the second reference information illustrated in step S12 are used as an example. After the first reference information and the second reference information are spliced, the obtained third reference information may be “You should generate content within the given constraints. Always assist with care, respect, and truth. Respond with utmost utility yet securely. Avoid harmful, unethical, prejudiced, or negative content. Ensure replies promote fairness and positivity.”.

Step S14: Inputting the target instruction and the third reference information into the language model to cause the language model to generate reply content for the target instruction based on the third reference information.

It can be understood that because the third reference information includes both the first reference information and the second reference information, and with integration ability of the language model, the language model may consider both non-toxic instructions and toxic instructions when generating the reply content for the target instruction, thereby reducing a miss rate of toxic instructions and improving a generation rate of non-toxic instructions.

In conclusion, in technical solutions of some embodiments of the present application, after the target instruction to be replied to by the language model is received, the first reference information used by the language model when replying to the non-toxic instruction and the second reference information used by the language model when replying to the toxic instruction are spliced to obtain the third reference information. Because the third reference information includes both the first reference information and the second reference information, after the third reference information and the target instruction are input into the language model, the language model may consider both non-toxic instructions and toxic instructions, so that generated reply content for the target instruction may achieve a balance between a generation rate and a miss rate.

The solution of the present application is further described below.

In some embodiments, instructions replied to by the language model are allowed to be classified into a plurality of instruction categories. For example, the instructions may be classified into a creation category, a conversion category, a knowledge inference category, a summarization category, and another category. An instruction may belong to one of the instruction categories. The language model uses different first reference information when replying to non-toxic instructions belonging to different instruction categories. For example, the first reference information used for a non-toxic instruction belonging to the creation category may be “You should generate imaginative and original content within the given constraints.”, and the first reference information used for a non-toxic instruction belonging to the conversion category may be “You should convert content within the given constraints.”. In view of this, obtaining first reference information used by the language model when replying to a non-toxic instruction in step S12 may include:
determining a target instruction category to which the target instruction belongs, and obtaining first reference information used by the language model when replying to a non-toxic instruction belonging to the target instruction category.

In this embodiment, instructions are classified into categories and different first reference information is set for instructions belonging to different instruction categories, so that the language model may better distinguish between different categories of non-toxic instructions, and then generate reply content that better matches the non-toxic instructions, so that accuracy of the reply content may be improved.

Further, considering that the language model may reply to toxic instructions belonging to different instruction categories by using the same or similar reply content, there may be no need to set different second reference information for the toxic instructions belonging to different instruction categories. That is, toxic instructions belonging to all instruction categories may have the same second reference information. In this way, data processing amount is reduced.

A training process of the language model of the present application is described below.

It can be understood by those skilled in the art that training data needs to be acquired and labeled before model training. In the present application, training data may include a toxic instruction-reply content pair including a toxic instruction and reply content for the toxic instruction, and a non-toxic instruction-reply content pair including a non-toxic instruction and reply content for the non-toxic instruction. Such labeling of the training data is relatively complex and inefficient. In view of this, the present application provides a training data generation method that is relatively efficient. FIG. 3 is a schematic flowchart of a training data generation method according to an embodiment of the present application. In FIG. 3, the training data generation method includes the following steps.

Step S31: Obtaining a toxic seed instruction.

Specifically, the so-called toxic seed instruction is a toxic instruction that may be used as a seed to generate more additional instructions. In this embodiment, as a seed, the toxic seed instruction may generate more other sample toxic instructions and sample non-toxic instructions.

Further, the toxic seed instruction can cover different instruction categories and toxicity categories. For example, it is assumed that the instruction categories include a creation category, a conversion category, a knowledge inference category, a summarization category, and another category, and the toxicity categories include violation of laws and regulations, and bad values. The toxic seed instructions may include:
instructions that violate laws and regulations and have bad values belonging to the creation category;
instructions that violate laws and regulations and have bad values belonging to the conversion category;
instructions that violate laws and regulations and have bad values belonging to the knowledge inference category;
instructions that violate laws and regulations and have bad values belonging to the summarization category; and
instructions that violate laws and regulations and have bad values belonging to other categories.

Step S32: Inputting the toxic seed instruction into a trained first generation model to generate a sample toxic instruction by the first generation model based on the toxic seed instruction.

Specifically, quantities of sample toxic instructions belonging to different toxicity categories may be determined based on a quantity of sample toxic instructions and a quantity of sample non-toxic instructions required for each instruction category. Then, the quantity of sample toxic instructions, the toxic seed instruction, and the toxicity categories may be input into the trained first generation model, and the first generation model uses the toxic seed instruction as a seed to generate a required quantity of sample toxic instructions.

In this embodiment, when the first generation model generates the sample toxic instructions, the following steps may be included.
(321) Generating candidate sample toxic instructions, score toxicity strength of each candidate sample toxic instruction, and label a toxicity category of each candidate sample toxic instruction. To put it simply, the first generation model may have a scoring function and a labeling function. For each candidate sample toxic instruction generated, the first generation model may score each candidate sample toxic instruction and label a toxicity category. A higher score of a candidate sample toxic instruction indicates a stronger toxicity of the candidate sample toxic instruction.
(322) After candidate sample toxic instructions whose scores are less than a score threshold (i.e., toxicity is insufficient) or whose toxicity categories are mismatched are eliminated, outputting the remaining candidate sample toxic instructions as sample toxic instructions.

In this way, the sample toxic instructions may be generated by using the first generation model.

In some other embodiments, the first generation model may output all the generated candidate sample toxic instructions directly without scoring the candidate sample toxic instructions or labeling toxicity categories. Then, candidate sample toxic instructions with insufficient toxicity or belonging to mismatched toxicity categories may be eliminated by manual screening.

Certainly, in some embodiments, a combination of screening by the first generation model and manual screening may alternatively be used to screen sample toxic instructions from the generated candidate sample toxic instructions. Specifically, in these embodiments, the first generation model may have a scoring function and a toxicity category labeling function. Among the generated candidate sample toxic instructions, if a score of a candidate sample toxic instruction is lower than a first score threshold or the toxicity category is mismatched, the first generation model may directly eliminate the candidate sample toxic instruction; if a score of a candidate sample toxic instruction is higher than a second score threshold and the toxicity category is matched, the first generation model may output the candidate sample toxic instruction as a sample toxic instruction; or if a score of a candidate sample toxic instruction is between the first score threshold and the second score threshold, the candidate sample toxic instruction may be output as an instruction to pass manual quality inspection, so as to manually determine whether the candidate sample toxic instruction may be used as a sample toxic instruction. The first score threshold is less than the second score threshold.

Step S33: Generating, based on the sample toxic instruction, a sample non-toxic instruction associated with the sample toxic instruction.

Specifically, the sample non-toxic instruction may be obtained by expanding or modifying the sample toxic instruction.

Step S34: Inputting the sample toxic instruction and the sample non-toxic instruction into a trained second generation model, and generating replies to the sample toxic instruction and the sample non-toxic instruction by the second generation model.

In this embodiment, similar to the first generation model, the second generation model, when generating replies to sample toxic instructions and sample non-toxic instructions, may also score the generated replies, and eliminate replies with lower scores and instructions corresponding to the replies. Relevant principles are not detailed herein.

Up to this point, training data for the language model may be obtained.

In some embodiments, the language model may be trained based on the following method:
inputting a sample non-toxic instruction and first sample reference information set for the sample non-toxic instruction into the language model, and adjusting a parameter of the language model and the first sample reference information based on first reply content for the sample non-toxic instruction; and
inputting a sample toxic instruction and second sample reference information set for the sample toxic instruction into the language model, and adjusting a parameter of the language model and the second sample reference information based on second reply content for the sample toxic instruction.

To put it simply, in a training phase of the language model, the language model may be trained based on sample non-toxic instructions and toxic instructions, respectively. In this way, the trained language model may better distinguish between features of sample non-toxic instructions and toxic instructions. In addition, the first sample reference information and the second sample reference information are adjusted in the training process of the language model, so that differences in features of the two sample reference information may be increased, which is beneficial for the language model to better learn the features of the two sample reference information.

Further, in some embodiments, sample non-toxic instructions are allowed to be classified into a plurality of instruction categories, and different first sample reference information is allowed to be set for sample non-toxic instructions belonging to different instruction categories. For instruction categories, refer to related descriptions in step S12. Details are not described herein.

The training the language model based on the sample non-toxic instruction may further include:
for any of the plurality of instruction categories, inputting a sample non-toxic instruction belonging to the instruction category and first sample reference information set for the sample non-toxic instruction belonging to the instruction category into the language model, and adjusting a parameter of the language model and the first sample reference information set for the sample non-toxic instruction belonging to the instruction category based on first reply content for the sample non-toxic instruction.

In this way, the trained language model may identify non-toxic instructions belonging to different instruction categories, and generate different reply content for non-toxic instructions belonging to different instruction categories.

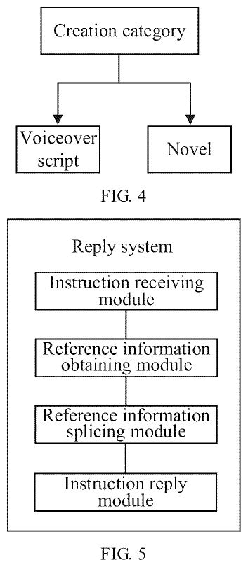

Further, each instruction category may include one or more sub-instruction categories, and different first sample reference information is allowed to be set for sample non-toxic instructions belonging to different sub-instruction categories. For ease of understanding, FIG. 4 is a schematic diagram of a structure of an instruction category according to an embodiment of the present application. In FIG. 4, a creation category is an instruction category. The creation category includes two sub-instruction categories, i.e., a voiceover script category and a novel category. Different first sample reference information is allowed to be set for sample non-toxic instructions belonging to two sub-instruction categories: a subject creation category and the novel category.

The training the language model based on the sample non-toxic instruction may include:

for any sub-instruction category of an instruction category, inputting a sample non-toxic instruction belonging to the sub-instruction category and first sample reference information set for the sample non-toxic instruction belonging to the sub-instruction category into the language model, and adjusting a parameter of the language model and the first sample reference information set for the sample non-toxic instruction belonging to the sub-instruction category based on first reply content for the sample non-toxic instruction.

In this way, the trained language model may distinguish between non-toxic instructions of different subcategories of the same instruction category, and generate different reply content.

Further, in some embodiments, each instruction category and each sub-instruction category have respective corresponding first sample reference information; and
for any sub-instruction category of an instruction category, first sample reference information may be set for a sample non-toxic instruction belonging to the sub-instruction category based on the following method:
splicing first sample reference information corresponding to the sub-instruction category and first sample reference information of the instruction category to which the sub-instruction category belongs to obtain the first sample reference information set for the sample non-toxic instruction belonging to the sub-instruction category.

For example, in FIG. 4, it is assumed that the first sample reference information for the creation category is “You should generate imaginative and original content within the given constraints.”, and the first sample reference information for the voiceover script category is “Conforming to the genre and format of a voiceover script, the description is in first-person perspective and does not involve dialogues.”. From “You should generate imaginative and original content within the given constraints. Conforming to the genre and format of a voiceover script, the description is in first-person perspective and does not involve dialogues.” obtained by splicing the two first sample reference information, first sample reference information set for a sample non-toxic instruction belonging to the voiceover script category may be obtained.

The first sample reference information that is set for the sample non-toxic instruction belonging to the sub-instruction category and that is obtained by this splicing method enables first sample reference information for different subcategories of the same instruction category to have both similarity and distinguishability, to facilitate exploration of integration ability of the language model.

Further, the language model trained according to the method described above may better distinguish between non-toxic instructions of different sub-instruction categories of the same instruction category based on the first sample reference information corresponding to the instruction category. In view of this, obtaining first reference information used by the language model when replying to a non-toxic instruction belonging to the target instruction category may include:
for a non-toxic instruction belonging to any of sub-instruction category of the target instruction category, using first reference information corresponding to the target instruction category as first reference information used by the language model when replying to the non-toxic instruction belonging to the sub-instruction category.

In this way, data processing amount is reduced.

Up to this point, related description of a method for voice enhancement of the present application is completed.

Corresponding to the method for voice enhancement, the present application further provides a voice enhancement system. FIG. 5 is a schematic diagram of modules of a reply system according to an embodiment of the present application. In FIG. 5, the reply system includes:
an instruction receiving module configured to receive a target instruction to be replied to by a language model;
a reference information obtaining module configured to obtain first reference information used by the language model when replying to a non-toxic instruction, and obtain second reference information used by the language model when replying to a toxic instruction;
a reference information splicing module configured to splice the first reference information and the second reference information to obtain third reference information needed for replying to the target instruction; and
an instruction reply module configured to input the target instruction and the third reference information into the language model to cause the language model to generate reply content for the target instruction based on the third reference information.

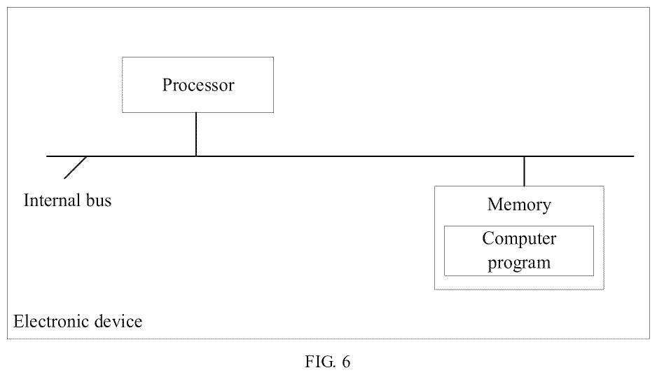

FIG. 6 is a schematic diagram of an electronic device according to an embodiment of the present application. The electronic device includes a processor and a memory, the memory is configured to store a computer program, and the computer program, when executed by the processor, causes the method to be implemented.

The processor may be a central processing unit (CPU). The processor may alternatively be another general-purpose processor, a digital signal processor (DSP), an application specific integrated circuit (ASIC), a field-programmable gate array (FPGA), or another programmable logic device, a discrete gate or transistor logic device, a discrete hardware component, and the like, or a combination of the chips.

As a non-transitory computer-readable storage medium, the memory may be configured to store non-transitory software programs, non-transitory computer-executable programs, and modules, such as program instructions/modules corresponding to the method in implementations of the present invention. The processor performs various functional applications and data processing of the processor by running the non-transitory software programs, the instructions, and the modules stored in the memory, that is, implements the method in the method implementations.

The memory may include a program storage area and a data storage area. The program storage area may store an operating system, an application required by at least one function; and the data storage area may store data created by the processor, and the like. In addition, the memory may include a high-speed random access memory, and may further include a non-transitory memory, such as at least one magnetic disk storage device, a flash memory device, or other non-transitory solid-state storage devices. In some implementations, the memory may optionally include memories that are remotely located with respect to the processor, and these remote memories may be connected to the processor over a network. Examples of the network include, but are not limited to, the Internet, an intranet, a local area network, a mobile communication network, and a combination thereof.

An implementation of the present application further provides a computer-readable storage medium. The computer-readable storage medium is configured to store a computer program, and when the computer program is executed by a processor, the method described above is implemented.

Although the implementations of the present disclosure are described with reference to the accompanying drawings, those skilled in the art would provide various modifications and variations without departing from the spirit and scope of the present disclosure, and such modifications and variations shall all fall within the scope defined by the appended claims.

I/We claim:

1. A method for replying, comprising:
receiving a target instruction to be replied to by a language model;
obtaining first reference information used by the language model in response to replying to a non-toxic instruction, and obtaining second reference information used by the language model in response to replying to a toxic instruction;
splicing the first reference information and the second reference information to obtain third reference information needed for replying to the target instruction; and
inputting the target instruction and the third reference information into the language model to cause the language model to generate reply content for the target instruction based on the third reference information.

2. The method according to claim 1, wherein instructions replied by the language model are allowed to be classified into a plurality of instruction categories, and the language model uses different first reference information in response to replying to non-toxic instructions belonging to different instruction categories; and
obtaining first reference information used by the language model in response to replying to a non-toxic instruction comprises:
determining a target instruction category to which the target instruction belongs, and obtaining first reference information used by the language model in response to replying to a non-toxic instruction belonging to the target instruction category.

3. The method according to claim 2, wherein each of the instruction categories comprises one or more sub-instruction categories, and the instruction category and each sub-instruction category have respective corresponding first reference information; and
obtaining first reference information used by the language model in response to replying to a non-toxic instruction belonging to the target instruction category comprises:
for a non-toxic instruction belonging to any of sub-instruction category of the target instruction category, using first reference information corresponding to the target instruction category as first reference information used by the language model in response to replying to the non-toxic instruction belonging to the sub-instruction category.

4. The method according to claim 1, wherein before the target instruction is received, the language model is trained based on the following method:
inputting a sample non-toxic instruction and first sample reference information set for the sample non-toxic instruction into the language model, and adjusting a parameter of the language model and the first sample reference information based on first reply content for the sample non-toxic instruction; and
inputting a sample toxic instruction and second sample reference information set for the sample toxic instruction into the language model, and adjusting a parameter of the language model and the second sample reference information based on second reply content for the sample toxic instruction.

5. The method according to claim 4, wherein sample non-toxic instructions are allowed to be classified into a plurality of instruction categories, and different first sample reference information is allowed to be set for sample non-toxic instructions belonging to different instruction categories; and
training the language model based on the sample non-toxic instruction comprises:
for any of the plurality of instruction categories, inputting a sample non-toxic instruction belonging to the instruction category and first sample reference information set for the sample non-toxic instruction belonging to the instruction category into the language model, and adjusting a parameter of the language model and the first sample reference information set for the sample non-toxic instruction belonging to the instruction category based on first reply content for the sample non-toxic instruction.

6. The method according to claim 5, wherein each of the instruction categories comprises one or more sub-instruction categories, and different first sample reference information is allowed to be set for sample non-toxic instructions belonging to different sub-instruction categories; and
training the language model based on the sample non-toxic instruction comprises:
for any of sub-instruction category of an instruction category, inputting a sample non-toxic instruction belonging to the sub-instruction category and first sample reference information set for the sample non-toxic instruction belonging to the sub-instruction category into the language model, and adjusting a parameter of the language model and the first sample reference information set for the sample non-toxic instruction belonging to the sub-instruction category based on first reply content for the sample non-toxic instruction.

7. The method according to claim 6, wherein each instruction category and each sub-instruction category have respective corresponding first sample reference information; and
for any of sub-instruction category of an instruction category, first sample reference information is set for a sample non-toxic instruction belonging to the sub-instruction category based on the following method:
splicing first sample reference information corresponding to the sub-instruction category and first sample reference information of the instruction category to which the sub-instruction category belongs to obtain the first sample reference information set for the sample non-toxic instruction belonging to the sub-instruction category.

8. The method according to claim 6, wherein before the language model is trained, training data for the language model is constructed based on the following method:
obtaining a toxic seed instruction;
inputting the toxic seed instruction into a trained first generation model to generate a sample toxic instruction by the first generation model based on the toxic seed instruction;
generating, based on the sample toxic instruction, a sample non-toxic instruction associated with the sample toxic instruction; and
inputting the sample toxic instruction and the sample non-toxic instruction into a trained second generation model to generate replies to the sample toxic instruction and the sample non-toxic instruction by the second generation model.

9. A non-transitory computer-readable storage medium, storing a computer program, wherein when the computer program is executed by a processor, causing the processor to:
receive a target instruction to be replied to by a language model;
obtain first reference information used by the language model in response to replying to a non-toxic instruction, and obtain second reference information used by the language model in response to replying to a toxic instruction;
splice the first reference information and the second reference information to obtain third reference information needed for replying to the target instruction; and
input the target instruction and the third reference information into the language model to cause the language model to generate reply content for the target instruction based on the third reference information.

10. The medium according to claim 9, wherein instructions replied by the language model are allowed to be classified into a plurality of instruction categories, and the language model uses different first reference information in response to replying to non-toxic instructions belonging to different instruction categories; and
the computer program causing the processor to obtain first reference information used by the language model in response to replying to a non-toxic instruction comprises instructions to:
determine a target instruction category to which the target instruction belongs, and obtain first reference information used by the language model in response to replying to a non-toxic instruction belonging to the target instruction category.

11. The medium according to claim 10, wherein each of the instruction categories comprises one or more sub-instruction categories, and the instruction category and each sub-instruction category have respective corresponding first reference information; and
the computer program causing the processor to obtain first reference information used by the language model in response to replying to a non-toxic instruction belonging to the target instruction category comprises instructions to:
for a non-toxic instruction belonging to any of sub-instruction category of the target instruction category, use first reference information corresponding to the target instruction category as first reference information used by the language model in response to replying to the non-toxic instruction belonging to the sub-instruction category.

12. The medium according to claim 9, wherein before the target instruction is received, the computer program causing the processor to train the language model comprises instructions to:
input a sample non-toxic instruction and first sample reference information set for the sample non-toxic instruction into the language model, and adjust a parameter of the language model and the first sample reference information based on first reply content for the sample non-toxic instruction; and
input a sample toxic instruction and second sample reference information set for the sample toxic instruction into the language model, and adjust a parameter of the language model and the second sample reference information based on second reply content for the sample toxic instruction.

13. The medium according to claim 12, wherein sample non-toxic instructions are allowed to be classified into a plurality of instruction categories, and different first sample reference information is allowed to be set for sample non-toxic instructions belonging to different instruction categories; and
the computer program causing the processor to train the language model based on the sample non-toxic instruction comprises instructions to:
for any of the plurality of instruction categories, input a sample non-toxic instruction belonging to the instruction category and first sample reference information set for the sample non-toxic instruction belonging to the instruction category into the language model, and adjust a parameter of the language model and the first sample reference information set for the sample non-toxic instruction belonging to the instruction category based on first reply content for the sample non-toxic instruction.

14. The medium according to claim 13, wherein each of the instruction categories comprises one or more sub-instruction categories, and different first sample reference information is allowed to be set for sample non-toxic instructions belonging to different sub-instruction categories; and
the computer program causing the processor to train the language model based on the sample non-toxic instruction comprises instructions to:
for any of sub-instruction category of an instruction category, input a sample non-toxic instruction belonging to the sub-instruction category and first sample reference information set for the sample non-toxic instruction belonging to the sub-instruction category into the language model, and adjust a parameter of the language model and the first sample reference information set for the sample non-toxic instruction belonging to the sub-instruction category based on first reply content for the sample non-toxic instruction.

15. The medium according to claim 14, wherein each instruction category and each sub-instruction category have respective corresponding first sample reference information; and
for any of sub-instruction category of an instruction category, the computer program causing the processor to set first sample reference information for a sample non-toxic instruction belonging to the sub-instruction category comprises instructions to:
splice first sample reference information corresponding to the sub-instruction category and first sample reference information of the instruction category to which the sub-instruction category belongs to obtain the first sample reference information set for the sample non-toxic instruction belonging to the sub-instruction category.

16. The medium according to claim 14, wherein before the language model is trained, the computer program causing the processor to construct training data for the language model comprises instructions to:
obtain a toxic seed instruction;
input the toxic seed instruction into a trained first generation model to generate a sample toxic instruction by the first generation model based on the toxic seed instruction;
generate, based on the sample toxic instruction, a sample non-toxic instruction associated with the sample toxic instruction; and
input the sample toxic instruction and the sample non-toxic instruction into a trained second generation model to generate replies to the sample toxic instruction and the sample non-toxic instruction by the second generation model.

17. An electronic device, comprising a processor and a memory, wherein the memory is configured to store a computer program, and when the computer program is executed by the processor, causing the processor to:
receive a target instruction to be replied to by a language model;
obtain first reference information used by the language model in response to replying to a non-toxic instruction, and obtain second reference information used by the language model in response to replying to a toxic instruction;
splice the first reference information and the second reference information to obtain third reference information needed for replying to the target instruction; and
input the target instruction and the third reference information into the language model to cause the language model to generate reply content for the target instruction based on the third reference information.

18. The device according to claim 17, wherein instructions replied by the language model are allowed to be classified into a plurality of instruction categories, and the language model uses different first reference information in response to replying to non-toxic instructions belonging to different instruction categories; and
the computer program causing the processor to obtain first reference information used by the language model in response to replying to a non-toxic instruction comprises instructions to:
determine a target instruction category to which the target instruction belongs, and obtain first reference information used by the language model in response to replying to a non-toxic instruction belonging to the target instruction category.

19. The device according to claim 18, wherein each of the instruction categories comprises one or more sub-instruction categories, and the instruction category and each sub-instruction category have respective corresponding first reference information; and
the computer program causing the processor to obtain first reference information used by the language model in response to replying to a non-toxic instruction belonging to the target instruction category comprises instructions to:
for a non-toxic instruction belonging to any of sub-instruction category of the target instruction category, use first reference information corresponding to the target instruction category as first reference information used by the language model in response to replying to the non-toxic instruction belonging to the sub-instruction category.

20. The device according to claim 17, wherein before the target instruction is received, the language model is trained based on the following method:
inputting a sample non-toxic instruction and first sample reference information set for the sample non-toxic instruction into the language model, and adjusting a parameter of the language model and the first sample reference information based on first reply content for the sample non-toxic instruction; and
inputting a sample toxic instruction and second sample reference information set for the sample toxic instruction into the language model, and adjusting a parameter of the language model and the second sample reference information based on second reply content for the sample toxic instruction.
